(19) United States
(12) Patent Application Publication
(10) Pub. No.: US 2008/0028854 A1
(43) Pub. Date: Feb. 7, 2008

(54) Devices, methods, and systems for measuring an optical property of a sample

(76) Inventor: Richard Wilson Evans, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/906,409

(22) Filed: Oct. 1, 2007

Related U.S. Application Data
(63) Continuation of application No. 10/997,169, filed on Nov. 24, 2004.

(51) Int. Cl. G01D 11/24

(52) U.S. Cl. 73/431

(57) ABSTRACT

Devices and methods are provided for measuring a property of a sample, such as an optical property. Embodiments of the subject invention include a device having sample measurement componentry and one or more enclosure-forming components, wherein one or more of the enclosure-forming components are movable, and wherein the device is configured so that one or more of the enclosure-forming components have a positional relationship that can change from an open position to a closed position in which one or more of the enclosure-forming components define an enclosed space accessible by the sample measurement componentry. Also provided are systems and kits.

### BACKGROUND OF THE INVENTION

A variety of different devices have been developed for characterizing a sample. Many of these devices use optical techniques for obtaining measurements of a sample, e.g., devices that employ photometery, spectrophotometery, fluorimetery and spectrofluorimetry. Characterizing a sample using optical techniques finds use in a wide variety of applications, e.g., chemical and biological qualitative and quantitative sample analysis.

Certain optical measurement devices may be characterized as “cuvettless” devices in that a sample to be measured is not contained within a cuvette, but rather is simply placed on a substrate and illuminated with light. The absorbance of light by the sample, determined by detecting the transmission or reflectance of light from the illuminated sample, may be used to characterize the sample. Cuvettless devices are described, for example, in U.S. Patent Publication Nos. 2002/0140931 A1 and 2002/0154299 A1, and elsewhere.

### SUMMARY OF THE INVENTION

Devices and methods are provided. In one embodiment, the subject devices provide an enclosed space accessible to optical components of the device. In one aspect, the device includes one or more enclosure-forming components in addition to optical componentry. One or more of the enclosure-forming components may move relative to the other enclosure-forming components to provide an enclosed space that is accessible to the optical componentry of the device. In one aspect, the one or more enclosure-forming components include first, second and third enclosure-forming components.

In one aspect, the first enclosure-forming component includes a sample-receiving surface for receiving a sample or a container containing a sample. In another aspect, the second enclosure-forming component includes a surface that is movable to oppose the sample-receiving surface. In still another aspect, the third-enclosure-forming component includes a shield for shielding a sample on the sample-receiving surface of a first enclosure-forming component from the environment and/or from ambient light.

In a further aspect, the positions of the first, second, and third enclosure-forming components relative to each other may be changed to generate the enclosed space (e.g., by moving one or more of the first, second and third enclosure-forming components). For example, the first, second and third enclosure-forming components may have a positional relationship that may change from an open position to a closed position, providing an enclosed space accessible by the optical componentry. In one aspect, the first enclosure-forming component includes a stage of an optical measuring device. In another aspect, the second enclosure-forming component includes optical componentry. In a further aspect, the third enclosure-forming component includes a shield.

Also provided are methods of measuring an optical property of a sample. Embodiments include positioning a sample within an enclosable space provided by a device that is accessible to sample measurement components of the device and measuring an optical property of the sample. In one aspect, the device includes one or more enclosure-forming components in addition to sample measurement componentry. One or more of the enclosure-forming components may move relative to the other enclosure-forming components to provide an enclosed space that is accessible to the sample measurement componentry of the device. In one aspect, the one or more enclosure-forming components include first, second and third enclosure-forming components. In one aspect, the first enclosure-forming component includes a sample-receiving surface for receiving a sample or a container containing a sample. In another aspect, the second enclosure-forming component includes a surface which is movable to oppose the sample-receiving surface. In still another aspect, the third-enclosure-forming component includes a shield for shielding a sample on the sample receiving surface from the environment.

The positions of the first, second, and third enclosure-forming components relative to each other may be changed to generate the enclosed space (e.g., by moving one or more of the first, second and third enclosure-forming components). For example, the first, second and third enclosure-forming components may have a positional relationship that may change from an open position to a closed position, providing an enclosed space accessible by the sample measurement componentry. In one aspect, the first enclosure-forming component includes a stage of an optical measuring device. In another aspect, the second enclosure-forming component includes optical componentry. In a further aspect, the third enclosure-forming component includes a shield.

Also provided are systems. Embodiments of the systems of the subject invention include a device as described above; and a processor coupled to or in communication with the device.

Also provided are components, e.g., shields, which may be used with optical measuring devices to provide an enclosed space accessible by sample measurement componentry.

Also provided are methods of measuring an optical property of a sample. Embodiments include positioning a sample within an enclosable space provided by a device that is accessible to optical componentry of the device, moving sample components relative to one another to form an enclosed space, and measuring an optical property of the sample. In one aspect, the device includes one or more enclosure-forming components in addition to the optical componentry. One or more of the enclosure-forming components may move relative to the other enclosure-forming components to provide an enclosed space that is accessible to the sample optical componentry of the device. In one aspect, the one or more enclosure-forming components include first, second and third enclosure-forming components. In one aspect, the first enclosure-forming component includes a sample-receiving surface for receiving a sample or a container containing a sample. In certain aspects, the sample-receiving surface is substantially planar. In certain aspects, the surface may comprise sample attracting and/or sample repellant areas, e.g., to aid in positioning the sample. In another aspect, the second enclosure-forming component includes a surface, which is movable to oppose the sample-receiving surface. In still another aspect, the third-enclosure-forming component includes a shield for shielding a sample on the sample receiving surface from the environment.

### BRIEF DESCRIPTIONS OF THE DRAWINGS

The figures shown herein are not necessarily drawn to scale, with some components and features being exaggerated for clarity.

FIG. 1 shows a cross-sectional view of an exemplary embodiment of a device according to the invention, that includes first, second and third enclosure-forming components in a first position.

FIG. 2 shows a cross-sectional view of an exemplary embodiment of a first enclosure-forming component according to the invention having a reduced cross-sectional dimension.

FIG. 3 shows a cross-sectional view of an exemplary embodiment of a device according to the invention wherein first and second enclosure-forming components are laterally offset from each other in a first position.

FIG. 4 shows a cross-sectional view of an exemplary embodiment of a device according to the invention. First, second and third enclosure-forming components of the device are in a first position with the first enclosure-forming component unattached from the second and third-enclosure-forming components.

FIG. 5 shows a cross-sectional view of an exemplary embodiment of a device according to the invention, that includes first, second and third enclosure-forming components in a second position.

FIG. 6 shows a side view of an exemplary embodiment of a device according to the invention having an enclosure-forming component that includes a shield attached to another enclosure-forming component that includes a head, in a first position.

FIG. 7 shows a side view of an exemplary embodiment of a device according to the invention having an enclosure-forming component that includes a shield attached to an enclosure-forming component that includes a stage, in a first position.

FIG. 8 shows a side view of an exemplary embodiment of a device according to the invention having an enclosure-forming component that includes a shield adapted to retract into an enclosure-forming component that includes a stage in a first position, and to extend from the stage in a second position.

### DESCRIPTION OF THE INVENTION

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents, and patent applications are incorporated by reference herein in their entireties. The citation of any publication, patent, or patent application is for its disclosure prior to the filing date and should not be construed as an admission that the present invention is not entitled to antedate such publication, patent, or patent applications by virtue of prior invention.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

The following definitions are provided for specific terms, unless context indicates otherwise.

The phrase “without substantial attenuation” may include, for example, without a loss of more than about 40% of light, e.g., without a loss of more than about 30%, without a loss of more than about 20%, without a loss of more than about 10%, without a loss of more than about 5% or less.

The term “opaque” refers to the absorbance of rays of a particular wavelength. An “opaque shield” (or other element as indicated) refers to a shield or element that permits less than about 20%, e.g., less than about 10%, e.g., less than about 5%, e.g., less than about 2%, e.g., less than about 1% or less of ambient light from reaching and/or that prevents more than 80%, more than 90%, more than 5%, more than 2%, more than 1% or more from reaching an enclosed microvolume space.

The term “light returning” or “reflective” when describing the property of a surface in the path of radiant energy refers to ¹the return back into the medium through which the radiation approached the surface of a portion of the incident radiant energy with no change in wavelength. In certain embodiments, a “light returning surface” refers to a surface or material which reflects or returns from about 2% to about 100% of incident radiant energy, e.g., from about 5% to about 100% radiant energy incident on the surface.

“Recess” refers to a trench, channel, groove or other analogous structure in a surface. A recess in a surface of an enclosure-forming component such as a stage surface may have a cross-sectional dimension, e.g., depth, width, length, diameter, etc., that is less than about 500 μm, e.g., between about 0.1 μm, and about 500 μm.

A “substantially flat” surface refers to a surface that has minimal deviation from flatness, e.g., does not deviate by more than about 0.001 mm to about 1 mm, e.g., by not more than about 0.002 mm to about 0.5 mm, e.g., by not more than about 0.005 mm to about 0.100 mm in certain embodiments.

“Positional relationship” refers to the relative position of a component with respect to one or more other components or the relative position of a plurality of components with respect to each other.

“Optional” or “optionally” means that the subsequently described circumstance may or may not occur, so that the description includes instances where the circumstance occurs and instances where it does not.

A “plastic” is any synthetic organic polymer of high molecular weight (for example at least 1,000 grams/mole, or even at least 10,000 or 100,000 grams/mole.

As used herein, a device component that is “flexible” is a component comprising a material that can be bent about 180 degrees around a roller of less than 1.25 cm in radius. In one aspect, a flexible component can be so bent and straightened repeatedly in either direction at least 100 times without failure (for example, cracking) or plastic deformation. This bending must be within the elastic limits of the material. In one aspect, the foregoing test for flexibility is performed at a temperature of 20° C.

As used herein, a device component that is “rigid” comprises a material which is not flexible, and is constructed such that a segment about 2.5 by 7.5 cm retains its shape and cannot be bent along any direction more than 60 degrees (and often not more than 40, 20, 10, or 5 degrees) without breaking.

“Deformable” refers to a material that may be compressed (optionally, reversibly compressed) e.g., to conform to a contacted surface.

“Remote location,” means a location other than the location at which the device is present or the method is performed. For example, a remote location could be another location (e.g., office, lab, etc.) in the same city, another location in a different city, another location in a different state, another location in a different country, etc. As such, when one item is indicated as being “remote” from another, what is meant is that the two items are at least in different rooms or different buildings, and may be at least one room, one mile, ten miles, or at least one hundred miles apart.

The term “assessing” and “evaluating” are used interchangeably to refer to any form of measurement, and includes determining if an element is present or not. The terms “determining,” “measuring,” “assessing,” and “assaying” are used interchangeably and include both quantitative and qualitative determinations. Assessing may be relative or absolute. “Assessing the presence of” includes determining the amount of something present, as well as determining whether it is present or absent.

“Fluorescence” broadly refers to the process whereby a material absorbs light at one wavelength and immediately re-emits it at another (usually longer) wavelength.

“Sample receiving surface” is meant a surface upon which a sample is deposited or otherwise positioned.

“Light” means any electromagnetic energy.

“Light source” is meant any item capable of providing electromagnetic energy.

“Light detector” is meant any item capable of detecting or registering electromagnetic energy.

A “computer”, “processor” or “processing unit” are used interchangeably and each references any hardware or hardware/software combination which can control components as required to execute recited steps. For example a computer, processor, or processor unit includes a general purpose digital microprocessor suitably programmed to perform all of the steps required of it, or any hardware or hardware/software combination which will perform those or equivalent steps. Programming may be accomplished, for example, from a computer readable medium carrying necessary program code (such as a portable storage medium) or by communication from a remote location (such as through a communication channel).

A “memory” or “memory unit” refers to any device which can store information for retrieval as signals by a processor, and may include magnetic or optical devices (such as a hard disk, floppy disk, CD, or DVD), or solid state memory devices (such as volatile or non-volatile RAM). A memory or memory unit may have more than one physical memory device of the same or different types (for example, a memory may have multiple memory devices such as multiple hard drives or multiple solid state memory devices or some combination of hard drives and solid state memory devices).

To “record” data, programming or other information on a computer readable medium refers to a process for storing information, using any such methods as known in the art. Any convenient data storage structure may be chosen, based on the means used to access the stored information. A variety of data processor programs and formats can be used for storage, e.g. word processing text file, database format, etc.

Additional terms are defined below in the context in which they are used.

In one embodiment, the invention provides device for determining (detecting, monitoring (e.g., evaluating changes in) and/or quantifying) an optical property of a sample (such as a liquid sample). In one aspect, the device includes a plurality of enclosure-forming components, e.g., “first”, “second” and “third” enclosure-forming components that define an enclosed space.

As used herein, an “enclosed space” refers to an area bounded on all sides. In certain embodiments, an enclosed space may contain less than about 10 ml of sample, e.g., less than about 1 ml of sample. In certain other embodiments, an enclosed space may comprise μl or nanoliter volumes, e.g., less than about 500 μl of sample, less than about 200 μl, less than about 100 μl of sample, less than about 50 μl of sample, less than about 25 μl of sample, less than about 10 μl of sample, less than about 5 μl of sample, or less than about 2 μl of sample. In certain embodiments, the volume of an enclosed space may range from about 1 cm³ to about 2 cm³, e.g. 3 cm³ to about 5 cm³, e.g., about 10 cm³ to about 20 cm³ or less.

One of the components (a “first enclosure-forming component”) is adapted to receive a sample, such as a liquid sample. In certain embodiments, a first enclosure-forming component includes a surface upon which a sample for measurement may be positioned. A first enclosure-forming component may have a rigid or semi-rigid surface, e.g., upon which a sample may be positioned. In certain embodiments, at least one surface of the first enclosure-forming component is substantially flat, although in some embodiments it may be desirable to physically separate regions of a first enclosure-forming component with, for example, wells, raised regions, etched trenches, channels, or the like. In some embodiments, the first enclosure-forming component itself may include wells, recesses, reservoirs, trenches, channels, etc. In certain aspects, the first enclosure-forming component (and any component which comes into contact with sample) may comprise surface modifications for facilitating analysis and/or positioning. For example, the surface may comprise, and/or be patterned with, sample-attracting and/or sample-repellant coatings, such as hydrophobic and/or hydrophilic coatings and the like.

In other aspects, a first enclosure-forming component may include or comprises a stage, where the stage has a substantially flat surface upon which a sample is received (e.g., by depositing a sample, such as a liquid sample, on the surface). In certain other aspects, the first enclosure-forming component does not comprise a well having at least one dimension of about 1 cm; however, the component may comprise some non-planar features, e.g., such as small depressions, reservoirs, and/or channels. Generally, such features will comprise dimensions of less than 1 cm in any one dimension. In still other aspects, where the first enclosure-forming component comprises a well, at least two or at least three other components are movable.

In still other aspects, the first enclosure-forming component may additionally include microfluidic componentry for moving liquids from one region of the component to another, e.g., such as pressure valves, septums, electrodes, and the like for moving fluids by electroosmotic or electrokinetic means.

In certain aspects, first enclosure-forming components of the subject invention together with other enclosure-forming components of the device are adapted to define an enclosed space such as an enclosed microvolume space (e.g., for receiving less than about 1 mm, less than about 500 μl of sample, less than about 200 μl, less than about 100 μl of sample, less than about 50 μl of sample, less than about μl of sample, less than about 10 μl of sample, less than about 5 μl of sample, or less than about 2 μl of sample).

In one embodiment, an enclosed space formed by enclosure-forming components is accessible by optical componentry of the device. As used herein, “optical componentry” refers to components for determining, monitoring (e.g., assessing changes in) and/or quantifying an optical property of a sample, for example, using photometric, spectrophotometric, fluorimetric and spectrofluorometric techniques. The term “optical property” refers to a characteristic of a sample detectable after it is exposed to a source of electromagnetic radiation or light. Optical properties that may be detected, monitored, and/or quantitated by the device include, but are not limited to absorbance, scattering, transmission, fluorescence, refraction, reflection, and the like.

“Accessible by” refers to access to and/or from. For example, an enclosed space that is “accessible by optical componentry” refers to a enclosed space which is in communication with optical componentry, such that characteristics of a sample within the enclosed space (e.g., optical properties, etc.) may be detected, monitored and/or quantified by the sample measurement componentry and/or a light path may be generated to and from a sample within the enclosed space such that optical properties from the sample may be detected by a detector in optical communication with the device (e.g., capable of receiving sufficient light from the sample to be detected by the particular detection system being used, to distinguish a signal relating to an optical property of an analyte sample being detected from background signal (e.g., produced by a blank sample, such as water, buffer or even air).

A first enclosure-forming component of the subject invention may include optical componentry. Optical componentry may include, but is not necessarily limited to a light source, elements for forming or defining a light path (e.g., one or more optical wave guides, optical fibers, lenses, mirrors, gratings, prisms, filters and the like) and/or elements for detecting an optical property of a sample (e.g., such as one or more detectors). Such componentry may also include or be in communication with a processing system—for example, signal processing circuitry may be connected to a photodetector for processing information received by the photodetector. In certain embodiments, one or more optical components may be operably linked to an actuator or motor (e.g., servo motor or piezo motor) and may be movable.

In certain aspects, a portion of the optical componentry may be an integral part of, or otherwise stably associated with an enclosure-forming component such as the first enclosure-forming component. For example, in certain aspects, optical componentry (e.g., a lens or surface comprising a lens, a surface comprising a light source, a detector or surface comprising a detector, or other optical components) may define an enclosure-forming component. In one aspect, a lens or surface comprising a lens may form a surface for receiving a sample and/or a container comprising a sample. As used herein, “stably associated with” includes, but is not limited to, affixing optical componentry to the surface of the enclosure-forming component (e.g., by an adhesive), providing a compartment or opening in a surface of the enclosure-forming components to receive the componentry, and holding the componentry by gravity on a surface of the component or by friction in the sample-containing portion of the enclosure-forming component(s) in optical communication with the sample.

In still other aspects, at least a portion of the first enclosure-forming component is at least partially transparent, allowing sufficient electromagnetic radiation to pass through to be detected by the particular detection system being used in or connected to the device to distinguish a signal relating to an optical property of a sample being detected from background signal (e.g., produced by a blank sample, such as water or even air). In one aspect, “an at least partially transparent component” refers to a component that permits from about 2% to about 100% of light to pass through, e.g., from about 5 to about 100% of light to pass through.

In one embodiment, one of the enclosure-forming components (a “second enclosure-forming component”) is adapted to form part of an enclosed space with one or more other enclosure forming components. In certain embodiments a second enclosure-forming component may include optical componentry or be stably associated with such componentry and/or be at least partially transparent.

In certain other aspects, both the second enclosure-forming component and the first enclosure-forming component form a sample containment area for holding a liquid sample and/or for receiving a container (e.g., such as a capillary) for holding a liquid sample. For example, the first and second enclosure-forming components may form or may be movable to form substantially planar parallel surfaces, which can contain a sample and/or sample container.

In one aspect, one of the enclosure-forming components (a “third enclosure-forming component”) is adapted to provide a barrier to one or more environmental influences from a sample under measurement and/or from sample measurement componentry. In certain aspects, a third enclosure-forming component may include a shield. For example, a third enclosure-forming component may be adapted to exclude ambient light from a sample under measurement and/or from sample measurement componentry, i.e., may be a light-excluding shield. In certain aspects, the first, second and third enclosure-forming components together provide barrier functions. In certain embodiments a third enclosure-forming component, may be movably affixed to the first or second enclosure-forming components.

In one aspect, the enclosed space is defined by the movement of one or more of enclosure-forming components of the device. In another aspect, the one or more moveable components, includes first, second and third enclosure-forming components. In a further aspect, one enclosure-forming component moves relative to a surface on which the device is placed, to form the enclosure with the remaining enclosure-forming components. In another aspect, at least two enclosure-forming components move relative to a surface on which the device is placed, to form the enclosure with the remaining enclosure-forming components. In still another aspect, at least three enclosure-forming components move relative to a surface on which the device is placed, to form the enclosure with the remaining enclosure-forming components. In a further aspect, an enclosed space may be defined by a first enclosure-forming component that includes a stage for receiving a sample, a second enclosure-forming component that includes optical componentry, and a third enclosure-forming component that includes a shield.

It should be noted that although first, second and third enclosure-forming components are described, the device may comprise additional enclosure-forming components which may or may not be movable relative to a surface on which the device is placed and that such components are included within the scope of the invention. Further, optical componentry may be included in or stably associated with two or more enclosure-forming components.

In one aspect, a third-enclosure forming component, or two or more enclosure-forming components in combination form a light-excluding barrier that prevents or reduces light, other than from a light source within the device, from reaching a sample in the enclosed space (or in a container within the enclosed space). In certain embodiments, light exclusion may refer to preventing from about 5% to about 100% light from passing through, e.g., from about 25% to about 100% light from passing through, e.g., from about 50% to about 100% light from passing through. In one aspect, a light-excluding barrier prevents sufficient light from outside of the space (“ambient light”) from penetrating the enclosed space such that a detector in optical communication with a sample in the space does not detect the outside light or detects the light to an insignificant level (in comparison with a signal associated with an optical property of a sample within the space). Enclosure-forming component(s), e.g., a shield, that is light excluding may be referred to a “light excluding shield” or a “light shield”, used herein interchangeably. In one embodiment, the internal surfaces of the enclosure-forming components, other than those in the direct light path to and from the sample, are non-reflective or light absorbing to reduce the amount of scattered light interference with the detection, monitoring and/or quantitation of light during operation.

As discussed above, the subject devices are adapted to provide an enclosed space (an enclosed microvolume space in certain embodiments) about a sample during operations of the device (e.g., generation of a light path to and from a sample, detection, monitoring, and/or quantifying an optical property of a sample), as will be described in greater detail below. In this manner, a sample may be shielded from various undesirable environmental influences such as ambient light that may interfere with the optical measurement of the sample. In one aspect, the enclosed space is accessible by the optical componentry of the device, thereby enabling enclosure of a sample during while an optical property of a sample within the enclosed space is detected, monitored, and/or quantitated.

In one embodiment, one or more, two or more, or three or more enclosure-forming components of the device may be moved relative to each other to define an enclosed space. In one aspect, the subject devices are configured so that the enclosure-forming components have a positional relationship than can change from a first open position which enables a sample to be placed on a surface of an enclosure-forming component or in a container on the surface, to a closed position in which the enclosure-forming components are in a second position in which the components define an enclosed space accessible by the sample measurement componentry. In one aspect, the enclosure-forming components substantially exclude ambient light from the enclosed space. In another aspect, the interior surface of the enclosure-forming components (other than those in the light path) are substantially light absorbing.

The size and shape the subject devices and thus the various components of the devices may vary and may range from large to small-scale devices, e.g., benchtop size devices or shelf-top sized devices. The subject optical devices may be configured to perform a wide variety of optical measurements and may be adapted for photometric, spectrophotometric, fluorimetric or spectrofluorometric analysis of a sample. The general principles of these types of instruments, as well as the sample measurement componentry used for each of these techniques are well known and understood by those skilled in the art and are described elsewhere, e.g., in text by Richard S. Hunter: The Measurement of Appearance, John Wiley & Sons, 1975; and Michael G. Gore: Spectrophotometry and Spectrofluorimetry: A Practical Approach; in text by Francis Rouessac and Annick Rouessac: Chemical Analysis: Modern Instrumentation Methods and Techniques; in text by Casimer Decusatis: Handbook of Applied Photometry; and elsewhere.

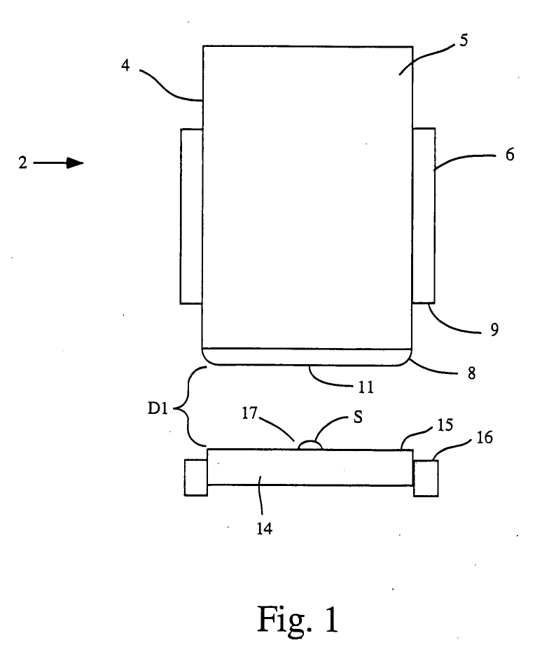

FIG. 1 shows a cross sectional view of an exemplary embodiment 2 according to the subject invention in a first position (also referred to as the “open position”). As shown, device 2 includes enclosure-forming component 4 having a body 5 and a contact plate 8, enclosure-forming component 6, and enclosure-forming component 14 having optional recess 16 for receiving a portion of shield 6 when the device is in a second position. It is to be understood that the particular shape and configuration of device 2 is for exemplary purposes only.

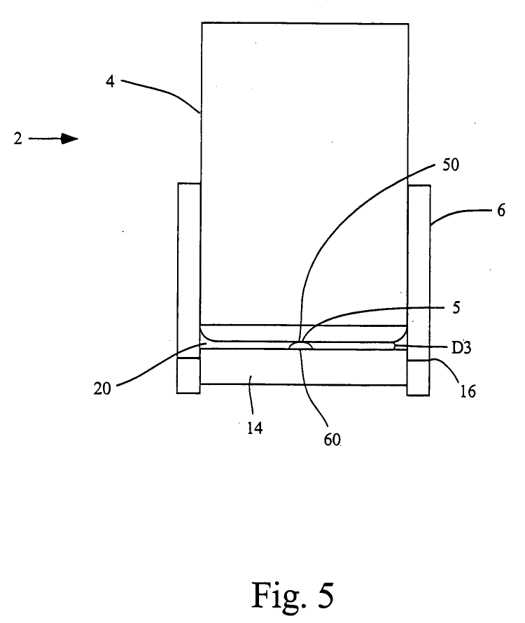

As noted above, in one aspect, the device 2 includes a first enclosure-forming component 14, which may or may not be moveable. The first enclosure-forming component 14 is adapted to receive and maintain a sample for analysis and may be adapted to serve a variety of other functions. For example, the first movable component 14 provides a portion of enclosed space 20 (see for example FIG. 5) and may include sample measurement componentry.

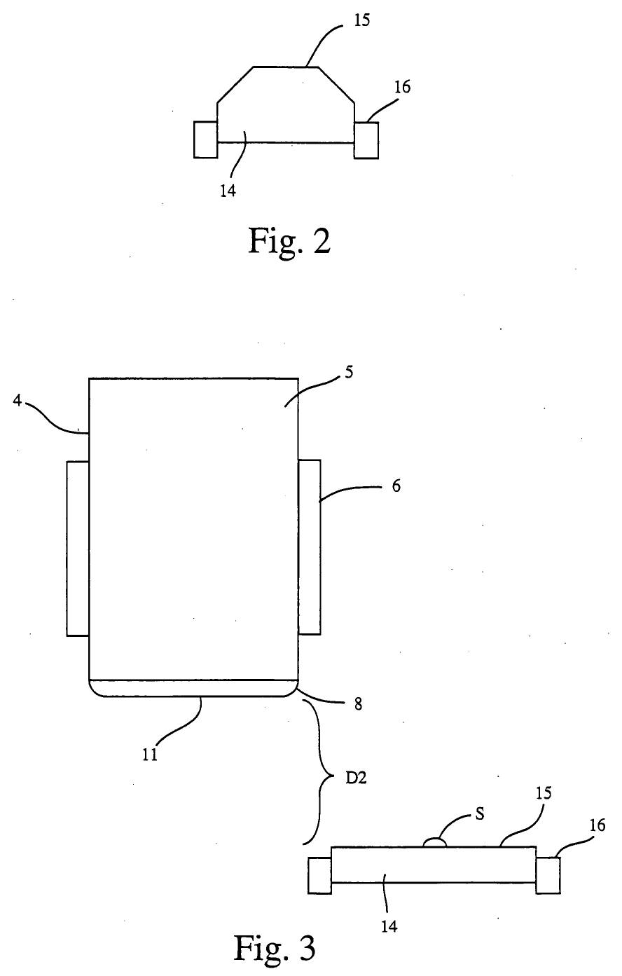

First enclosure-forming component 14 may be any shape or size and is shown here as a substantially rectangular shape. However, first enclosure-forming component 14 may be any shape, ranging from simple to complex. For example, first enclosure-forming component 14 may have a tapered cross-sectional dimension, e.g., a tapered cross-sectional diameter such as a frustum shape or the like. An embodiment of first enclosure-forming component 14 having a tapered cross-sectional diameter is shown in FIG. 2. In one aspect, first enclosure-forming component 14 may include or otherwise define a stage. Stages having tapered cross-sectional shapes that may be adapted for use in the subject invention include anvils described, for example, in U.S. Patent Publication Nos. 2002/0140931 A1 and 2002/0154299 A1.

In one aspect, first enclosure-forming component 14 includes sample-receiving surface 15, upon which a sample S is shown positioned, so that optical measurements of the sample may be obtained. In certain embodiments, the sample-receiving surface is substantially flat or planar. Unlike other sample receiving surfaces of conventional analytical devices which may include a well into which sample is deposited for analysis, either directly (i.e., the sample receiving surface is a bottom surface of a well), or into a cuvette, held in the well, the subject invention includes stages for receiving a sample that are without sample-receiving wells. In such instances the sample may be deposited on a top surface of a first enclosure-forming component, e.g., a top surface of a stage, and the sample-receiving surface is easily accessible for cleaning and sample deposition. In certain embodiments, when device 2 is in a first position, the sample-receiving surface is barrier-free, i.e., there are no barriers or walls around the area of the stage adapted to receive the sample. Sample receiving surface 15 may be substantially flat and may incorporate certain features to facilitate sample receiving and/or optical measurement of a sample, e.g., such as measurements of opacity, transparency, and the like, as described in greater detail below.

First enclosure-forming component 14, or a portion thereof, may be adapted for translational movement, e.g., movement in the X (right and left) and/or Y (back and forth) and/or Z (up and down) directions. Such translational movement of may be accomplished manually, e.g., with the use of manually actuated control knobs, levers, cranks, or the like, or automatically by way of a coupled, automated translational system. For example, the magnitude of movement of the first movable component in the X and/or Y and/or Z direction may range from micrometers to millimeters to centimeters, in certain embodiments. The first enclosure-forming component 14 may additionally, or alternatively, be rotated and/or tilted in certain embodiments.

In one aspect, sample-receiving surface 15 is adapted for receiving a sample so that optical measurements can be performed on the sample using optical componentry coupled to device 2. A portion, or all of, sample-receiving surface 15 may be transparent in certain embodiments and in certain embodiments, a portion may be opaque or reflective. For example, certain stage embodiments may include a transparent portion 17 at which an amount of sample is deposited, embedded in an opaque surrounding portion. Such transparent, sample-receiving portion 17 of the stage may have surface energy characteristics different from the surrounding portion. The different surface energy may be used to secure or confine a liquid sample in the sample-receiving portion of the stage. For example, where the sample intended to be deposited on the sample-receiving surface is an aqueous solution, the sample-receiving portion of the surface 17 may be more hydrophilic than the surrounding region of the surface, thereby preventing spread of the sample, providing more uniformity in sample shape and height and assuring alignment of the sample in relation to the light path. The size of the hydrophilic sample-receiving portion and/or the volume of sample may be varied to adjust the height of the sample droplet. Generally, any surface-contacting component of the device may comprise or be patterned with different surface-energy-generating coatings.

In operation, in some embodiments, placement of sample at a region 17 positions the sample in an appropriate relationship with the optical componentry when the device assumes a closed position in which enclosure-forming components of the device define an enclosed space about the sample, as will be described in greater detail below.

In one aspect, device 2 also includes a second enclosure-forming component 4, which may or may not be moveable. The second enclosure-forming component 4 may be adapted to serve a variety of purposes. For example, second enclosure-forming component 4 may provide a portion of enclosed space 20 and/or may include optical componentry. In certain alternative or additional embodiments, the second enclosure-forming component together with the first enclosure-forming component, in the closed position, may retain and position a liquid sample, e.g., by providing opposing surfaces against which a liquid sample may be held by surface tension, or by retaining a container between the opposing surfaces in a suitable light path defined by the relative positions of optical componentry of the device.

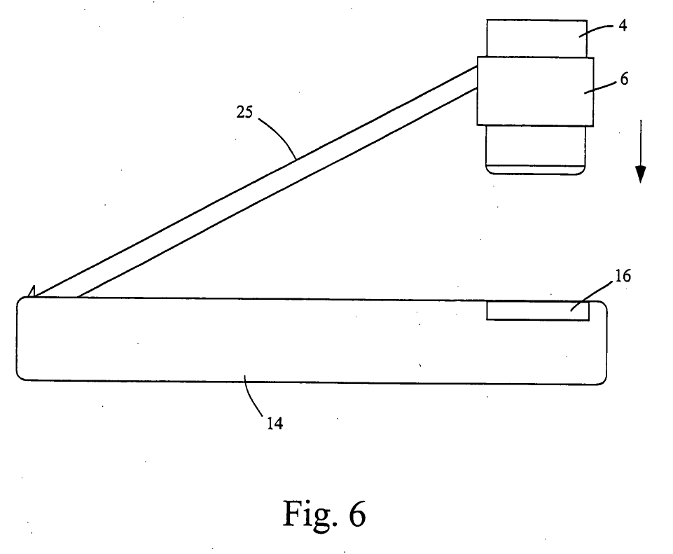

Second enclosure-forming component 4 is shown unattached to first enclosure-forming component 14 in FIG. 1, but may be attached to the first enclosure-forming component 4 in certain embodiments, e.g., via a moveable arm or the like (see for example FIGS. 6, 7 and 8). Second enclosure-forming component 4 includes body 5 and contact plate 8 at the proximal end of second enclosure-forming component 4. In certain embodiments, second enclosure-forming component 4 may be physically contacted with a sample to be measured, e.g., the second enclosure-forming component may be physically contacted with the sample and the sample may be held in place between the two opposing surfaces of the first movable component and the second movable component. In this manner, a portion of a surface of second enclosure-forming component 4 brings an opposing, sample contacting surface in proximity to sample receiving surface 15. For example, as shown in the Figure, the second enclosure-forming component may comprise a contact plate 8 for receiving a sample.

It will be apparent that contacting the sample with a contact plate 8 is but one technique for performing optical measurements on the sample. In certain other embodiments, there may be no contact plate and body 5 may not be physically contacted with the sample and may remain a distance from the sample during the sample measurement.

Second enclosure-forming component 4 may be adapted for translational movement, e.g., movement in the X (right and left) and/or Y (back and forth) and/or Z (up and down) directions. Such translational movement may be accomplished manually, e.g., with the use of manually actuated control knobs or the like, or automatically by way of a coupled, automated translational system. For example, the magnitude of movement in the X and/or Y and/or Z direction may range micrometers to millimeters to centimeters (e.g., up to tens or hundreds of centimeters) in certain embodiments. In certain embodiments, the second enclosure-forming component 4 may be tilted and/or rotated.

In one aspect, device 2 is in communication with optical componentry. As noted above, optical componentry for performing optical measurements on a sample, e.g., using photometric, spectrophotometric, fluorimetric and spectrofluorometric techniques is known to those of skill in the art and will not be described herein in great detail (see for example U.S. Pat. Nos. 5,422,726; 5,345,395; 5,122,974; 4,252,617; 4,595,833; 3,975,098; and 3,973,129). In general, optical sample measurement componentry typically includes a source of light (e.g., light emitting diode or the like), a photodetector for detecting light reflected from or transmitted through the sample (see e.g., US Patent Application Publication No. 20010008287) and a processing system, for example signal processing circuitry connected to the photodetector for processing information received by the photodetector. Additional optical componentry included within the scope of the invention include optical waveguides (e.g., such as optical fibers), lens, mirrors, focusing elements, gratings, filters, and the like.

For example, device 2 may be configured as a spectrophotometer that includes a light source operative to emit a beam of light, a system for directing the light beam to a sample to be analyzed, and a detector which detects the intensity of the light beam after the beam interacts with the sample. The light source may be operative to emit continuous light or bursts of light separated by an interval during which no light is emitted. By way of example, a xenon tube, deuterium lamp, tungsten lamp or the like may be used for that purpose. The spectrophotometer may be adapted to measure the intensity of the light beam generated by each burst of light after that beam interacts with the sample.

Depending on the particular configuration of the device and particular type of optical measurement (e.g., whether photometric, spectrophotometric, fluorimetric, spectrofluorometric, etc.), additional sample measurement componentry may be coupled to device 2. Such additional sample measurement componentry may include, but is not limited to one or more of: mirror(s), focusing element(s), monochromator(s), filter(s), beamsplitter(s), polarizer(s), interferometer(s), etc.

Device 2 may be a processor-controlled, single or double beam diode array spectrophotometer that operates in the visible, ultraviolet and infrared portions of the electromagnetic spectrum. The sample measurement componentry may include a first light source, such as a deuterium source, xenon flashlamp, or the like, a second light source with emission characteristics differing from those of the first light source, a lens system including one or more of an elliptical lens, concave holographic grating and a diode array, for simultaneous detection at all wavelengths.

Sample measurement componentry also may include one or more processing systems for controlling the sample measurement components of the device and/or for managing user interface functions and/or processing signals obtained at the detector. For example, one or more microprocessors may be used. A processing system may include two separate microprocessor systems: one configured to control the internal hardware of the sample measurement componentry such as a lamp, shutter, diode array, preamp, etc., and the other to control user interface functions such as interpretation of command entries, data management and control of peripherals or other components of the device (e.g., such as the first and second movable components). In some aspect, the microprocessor for controlling interface functions executes instructions based on sample measurements obtained by a detector or other sample measurement componentry. For example, the microprocessor for controlling interface functions may direct movement of one or more movable components of the device in response to a measurement obtained.

Sample measurement componentry may be positioned in any suitable location in optical communication with an enclosed space and may be directly mounted in or to the device itself, e.g., mounted in or to one or more of the enclosure-forming components. For example, Sample measurement componentry may be mounted in or to a first enclosure-forming component and/or second enclosure-forming component, or may be external to the first and/or second enclosure-forming components, but coupled thereto. For example, a light source and detector may both be mounted in a first enclosure-forming component that includes a stage or both may be mounted in a second enclosure-forming component, such as a head. Alternatively, a light source may be mounted in the first enclosure-forming component and a detector may be mounted in the second enclosure-forming component, or vice versa. Still further, a light source and/or detector may be positioned elsewhere and one or more optical fibers may be used to carry light to or from a light source or detector, e.g., from a light source to the sample for illumination of the sample. For example, a light source may be positioned in a first enclosure-forming component having the sample receiving surface or elsewhere. An optical fiber may be coupled to the light source at one end while the other end of the optical fiber is disposed in proximity to the second enclosure-forming component in a manner to illuminate a sample positioned on the sample-receiving surface with light. A variety of configurations will be readily apparent to those of skill in the art. The subject devices will be further described primarily with respect to a light source mounted in the second enclosure-forming component and a detector in the first enclosure-forming component for exemplary purposes only, where such description is in no way intended to limit the scope of the invention.

In another aspect, the device includes a third enclosure-forming component 6. In one aspect, the third movable component includes or otherwise defines a shield. Third enclosure-forming component 6 is shown moveably attached to enclosure-forming component 4 in FIGS. 1, 2 and 3, but may be alternatively attached to enclosure-forming component 14, moveably or otherwise. In other embodiments, third enclosure-forming component 6 may not be attached to either the first or the second enclosure-forming components, but may be separate therefrom, and/or moveable relative to the first and second enclosure-forming components—manually or automatically, into a position to provide an enclosed space defined by a surface of the first, second and third enclosure-forming components. In certain embodiments, third enclosure-forming component 6 may be attached to a moveable arm so that the arm may move the shield into position to generate the enclosed space 20 when so desired. The arm may or may not be the same arm used to move one or more other components of the device.

As shown in FIG. 5, third enclosure-forming component 6, together with the first and the second enclosure-forming components may be positioned to provide an enclosed space 20. The volume of enclosed space 20 may vary depending of the particular configuration of the device. In certain embodiments the space may be a microvolume space. Any or all of the first, second, or third enclosure-forming components may be moved to provide this enclosed space.

When a sample is deposited on surface 15 of first enclosure-forming component 14, a enclosed space is provided around the sample so that the sample is bound on all sides by surfaces of the first, second and third enclosure-forming components, as shown in FIG. 5. In one aspect, the first and second enclosure-forming components include opposing surfaces and the third enclosure-forming component 6 provides 360° of shielding around a sample within the enclosed space. In this manner, one or more undesirable environmental influences are prevented from entering the enclosed sample space and thus prevented from reaching or otherwise interfering with or contacting the sample and/or sample measurement componentry. It can be appreciated that such enclosure does not need to provide absolute environmental shielding for the sample for the benefits of such enclosure to be present. The benefits of environmental shielding will be significant even if the shielding is not entirely airtight or light proof. The degree of shielding needed will vary, for example, depending on the stability and volatility of the sample and the characteristics of the ambient environment, including illumination level and temperature. For example, many of the benefits of the enclosure will still be present if only 350° of shielding is present or if the shielding stops from about 30% o to about 100% of the ambient light from reaching the sample during measurement. Further, as shown in the embodiment illustrated in FIG. 5, enclosure component 6 may be slidably connected to element 4. Depending on the tolerances of the manufacturing processes used and the design choices made, it is likely that the opposing surfaces of component 6 and component 4 will not form a perfectly light-proof or air-proof seal. While close tolerances may be desirable particularly where the device will be used in harsh or bright environments, a perfect seal is not necessary to obtain benefits from the enclosure.

In certain embodiments, third enclosure forming component 6 may be tubular in shape, e.g., in the form of a cylinder, cone, and the like, but in any event, has a first end for contact with the first enclosure-forming component and a second end for contact with second enclosure-forming components and includes an opening therebetween.

The third enclosure forming component 6, when used to form the enclosed space, may provide a barrier to one or more environmental influences, e.g., gases, ambient light, moisture, dust or other particulates, etc. Using third enclosure forming component 6 to form the enclosed space may also reduce evaporation of the sample which may occur during measurement. Accordingly, the particulars of the construction of third enclosure forming component 6 may vary depending on the particular desired uses of the third enclosure forming component, e.g., whether it is desirable to block the inward diffusion of ambient light and/or gas and/or dust, etc., from the enclosed space.

Third enclosure forming component 6 may be fabricated from a wide variety of materials. Of interest are materials that are substantially impermeable to ambient light and in many embodiments substantially impermeable to ambient light such that when the third enclosure forming component 6 and first and second enclosure-forming components are in a positional relationship to define enclosed space 20, ambient light is not able to penetrate through third enclosure forming component 6 to the interior of enclosed space 20.

Examples of materials which may be used to fabricate shield 6 include, but are not limited to, metals or metal alloys, polymers, plastics, ceramics, e.g., such as aluminum (e.g., aluminum or an aluminum alloy such as Al—Si, Al—Ti, Al—Cu, Al—Si—Ti and Al—Si—Cu, or others), silver, gold, platinum, chrome, tantalum, silicon nitride, and the like. In certain embodiments, a third enclosure-forming component may include tungsten, e.g., may be made from tungsten (W) or titanium-tungsten (TiW), e.g., may include a tungsten layer, etc. Other materials will be readily apparent to those of skill in the art in view of the disclosure herein.

In certain embodiments, third enclosure-forming component 6 may be totally or partially in the form of a rigid or deformable gasket or the like, i.e., an o-ring. Gaskets that may be adapted for use with the subject invention include those described in commonly assigned U.S. application Ser. No. 10/172,850, entitled “Form in Place Gaskets for Assays.

Any material having suitable characteristics may be used as gasket material. Suitable gasket material may derive from naturally occurring materials, naturally occurring materials that have been synthetically modified, or synthetic materials. Gasket materials may be fluid materials that may be cured to provide a solid gasket shield structure having suitable characteristics. Suitable gasket materials include, polymers, elastomers, silicone sealants, urethanes, and polysulfides, latex, acrylic, etc. Of interest are silicone sealant materials such as Loctite 5964 thermal cure silicone. In certain embodiments, the gasket shield material is a fluoropolymer such as polytetrafluoroethylene, e.g., a Teflon® such as a liquid Teflon®, e.g., Teflon® AF which are a family of amorphous fluoropolymers provided by E.I. du Pont de Nemours and Company.

Materials that may be used in the fabrication of gasket enclosure-forming components include “self-leveling” materials such as self-leveling silicone materials. These self-leveling materials aid in the manufacture of the gaskets. By using a low viscosity (about 15,000 to about 50,000 cps, or centipoises) silicone that is “self leveling”, a very small bead of silicone can be used to form a gasket enclosure-forming component, e.g., applied to a substrate surface such as a surface of a stage or the like. Because it is self-leveling, the small bead of silicone will spread out to a thin profile, or cross section.

As mentioned above, a gasket enclosure-forming component may be formed directly on a surface of a device, e.g., directly on an enclosure-forming component surface such as a stage surface or contact plate surface (e.g., the perimeter of the contact plate surface) or may be formed elsewhere and then transferred to a device after it has been formed.

Regardless of the particular material used to fabricate third enclosure-forming component 6, in certain embodiments at least a portion of an enclosure-forming component 6 may be hydrophobic, where the material of a third enclosure-forming component may be inherently hydrophobic or be made hydrophobic, e.g., by a hydrophobic agent, chemical manipulation, etc. By “hydrophobic” it is meant that at least a portion of a surface of a third enclosure-forming component is substantially if not completely unwettable and substantially if not completely liquid repellant for the sample retained therein, even if the sample is not an aqueous solution. For example, in the case of an oily-based sample, a shield or surface thereof may correspondingly be a lipophobic surface. For example, the interior surface of a third enclosure-forming component 6 or a portion thereof may be hydrophobic. In certain cases, a hydrophobic enclosure-forming material may be laid down before or after sample deposition on a first enclosure-forming surface, to create a seal between a first enclosure-forming surface and a second-enclosure forming surface that defines an enclosed volume space between the first and second-enclosure forming surface. Hydrophobic materials include, but are not limited to silicone, Teflon, polyacrylates, and the like.

The dimensions of a third enclosure-forming component 6 will vary depending on the material of the third enclosure-forming component and the dimensions of the other enclosure forming components. By way of example, in embodiments in which the third enclosure-forming component 6 is made of polydimethylsilica, transparent Teflon, dimethylacrylate, and like material and is employed at least to prevent ambient light from reaching enclosed space 20, the thickness of the third enclosure-forming component 6 is sufficient to provide an enclosed space of suitable dimensions to receive about 1 ml of sample or less, about 500 μl of sample or less, about 200 μl or less, about 100 μl or less, about 50 μl or less, about 25 μl or less, about 10 μl or less, about 5 μl or less, or about 2 μl or less. In one aspect, the dimensions of the space are at least about 0.15 μl. In certain aspects, however, the thickness of the third enclosure-forming components is at least about 1 cm, at least about 5 cm, or at least about 10 cm.

As noted above, in many embodiments third enclosure-forming component 6 is opaque or otherwise substantially non-transmissive to light to shield enclosed space 20 from ambient light. As such, the material of a third enclosure-forming component 6 may be inherently opaque to light or rendered opaque to light (e.g., by coating component 6 with an appropriate coating). Third enclosure-forming component 6 may also be reflective. As such, the material of third enclosure-forming component 6 may be inherently reflective or rendered reflective.

Third enclosure-forming component 6 may be flexible or rigid or may be both flexible and rigid such that a portion of third enclosure-forming component 6 may be rigid and a portion may be flexible. In certain embodiments, at least a portion of third enclosure-forming component 6, e.g., one or more edges of the third enclosure-forming component, may be deformable so as to conform to a contacted surface of one or more other enclosure-forming components. In this manner, a tight seal may be formed at the contacting areas of third enclosure-forming component 6 and the first enclosure-forming component and/or second enclosure-forming component. For example, a leading edge of third enclosure-forming component 6 may be deformable to provide a light-proof seal with a contacting surface, e.g., with a surface of a first enclosure-forming component such as a recessed stage surface.

Positional Relationship of Enclosure-forming Components

As described above, in one aspect, a device 2 is configured so that first enclosure-forming component 14, second enclosure-forming-component 4 and third enclosure-forming component 6 have a positional relationship that can change from a first open position to a second closed position in which the enclosure-forming components define an enclosed space 20 accessible by optical componentry of the device. For example, embodiments include at least a first, second and third enclosure-forming component wherein a first enclosure-forming component defines a sample receiving surface or stage and optionally, comprises or is stably associated with optical componentry, a second enclosure-forming component, which, together with the first enclosure-forming component may form a sample containment area, and optionally may comprise optical componentry, and a third enclosure-forming component, which by itself, or in combination with outer surfaces of the first and second-enclosure forming components (i.e., surfaces exposed to ambient light) may form a shield against ambient light.

An exemplary first position is shown in FIGS. 1, 3, 4 and 6. In the first position, device 2 may be described as being in the open position in that enclosed space 20 is not provided. In one aspect, in the open position, surface 15 of first enclosure-forming component 14 is accessible for cleaning and for sample deposition thereon and a surface of the second enclosure-forming component, is accessible for cleaning, e.g., available to be wiped clean with lens tissue or the like. In certain aspects, the second enclosure-forming component comprises a contact plate 8 which extends beyond edge 9 of a third enclosure-forming component 6, which facilitates cleaning of the contact plate.

A distance, herein represented as D1 in FIG. 1, is provided between leading edge 11 of contact plate 8 and surface 15 of enclosure-forming component 14 in the open position. D1 may range from about 10 μm to about 2 mm, or from about 50 μm to about 5 cm, or from about 50 μm to about 2 cm. The exact dimension of D1 is not critical so long as the enclosure-forming surfaces comprise suitable dimensions to enclose sample volumes of ranges described above or containers dimensioned so as to contain such volumes, when the enclosure-forming surfaces are in the closed position.

It will be apparent that other positional relationships may be assumed which also provide an open position. For example, the first and second enclosure-forming components may be laterally spaced apart in the open position such as shown in FIG. 3. In this regard, a surface of the second enclosure-forming component, such as contact plate 8 and sample receiving surface 15 of the first enclosure-forming component are spaced apart at least in part by virtue of the lateral offset and thus distance D2 provided between edge 11 of the contact plate 8 and the surface 15 of the stage 14 may or may not equal D1 of the embodiment of FIG. 1, e.g., 10 μm to about 2 mm, or from about 50 μm to about 5 cm, or from about 50 μm to about 2 cm. In any event, device 2 is capable of assuming an open configuration whereby enclosed space 20 is not provided and sample can be deposited onto surface 15 of enclosure forming component 14 and both stage surface 15 and contact plate 8 are accessible for cleaning.

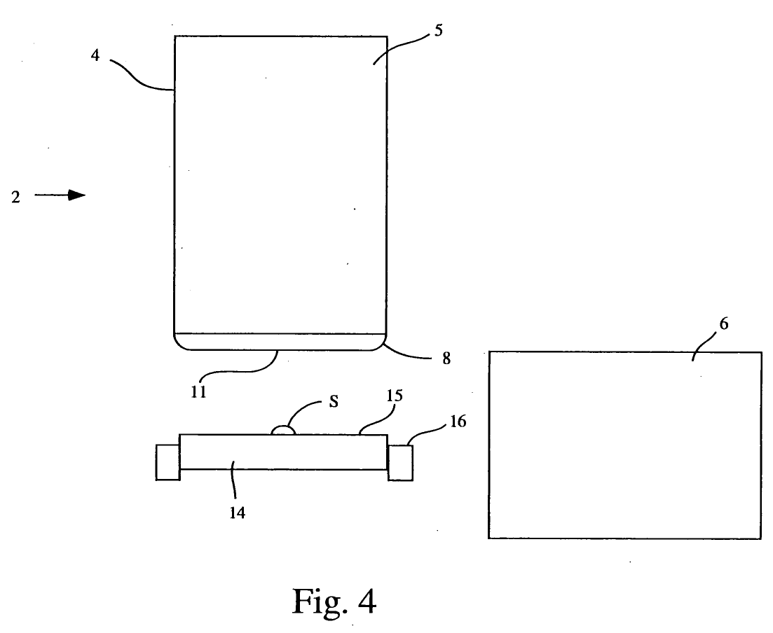

In this open position, third enclosure-forming component 6 is positioned in a manner that enables a sample to be deposited onto surface 15 as noted above. In the embodiments shown in the figures, third enclosure forming component 6 is moveably attached to the body of second enclosure-forming component 4, and contact plate 8 extends beyond edge 9 of third enclosure forming component 6 in the open position. Other configurations will be apparent. For example, in embodiments in which third enclosure forming component 6 is attached to first enclosure-forming component 14, surface 15 of first enclosure-forming component 14 may extend beyond leading edge 9 of third enclosure-forming component 6 in the open position, as shown for example in FIG. 6 in which third enclosure-forming component 6 is retractable into recess 16 of first enclosure-forming component 14 in the open position. FIG. 4 shows another exemplary embodiment in which third enclosure-forming component 6 is not attached to the first or second enclosure-forming components, but is configured to be positionable in an open position whereby a sample is able to be deposited onto surface 15 of first enclosure-forming component 14.

FIG. 5 shows first enclosure-forming component 14, second enclosure-forming component 4 and third enclosure-forming component 6 in a second, closed position (which may also be characterized as the measurement position), whereby enclosed space 20 is provided and third enclosure-forming component 6 extends between first enclosure-forming component 14 and second enclosure-forming component 4, i.e., third enclosure-forming component 6 is positioned around the contact plate and extends to first enclosure-forming component 14, e.g., recess 16 of first enclosure-forming component 14. As shown, enclosed space 20 is defined by enclosure-forming component 6 and by the opposing surfaces of enclosure-forming component 4 and in particular contact plate 8 of enclosure-forming component 4 and enclosure-forming component 14.

Depending on the particular arrangement of enclosure-forming component 4, enclosure-forming component 14 and enclosure-forming component 6 in the open position, one or more of these enclosure-forming components may be moved to provide the closed position- or third enclosure-forming component 6 may be the only component moved and enclosure-forming component 4 and enclosure-forming component 14 may remain stationary. For example, in the embodiment of FIG. 1 in which the third enclosure-forming component 6 is attached to the second enclosure-forming component 4 and the open position is characterized by the contact plate extending beyond leading edge 9 of the third enclosure-forming component, third enclosure-forming component 6 is adapted to move to a second position wherein a portion of the third enclosure-forming component is extended beyond the second enclosure-forming component 4, i.e., the third enclosure-forming component 6 extends around the contact plate and to first enclosure-forming component 14.

In any event, device 2 is capable of assuming a closed position wherein the surfaces of first enclosure-forming component 14 and second enclosure-forming component 4 are spaced apart a distance D3 and third enclosure-forming component 6 is position between the first and second enclosure-forming components such that a portion of third enclosure-forming component 6 is in contact with second enclosure-forming component 4 and a portion of third enclosure-forming component 6 is in contact with first enclosure-forming component 14. In certain embodiments, distance D3 may be characterized as the distance required to contact plate 8 with sample S and may or may not be the same as D1 and D2, e.g., may be less than D1 and/or D2. D3 may range from about may range from about 10 μm to about 2 mm, or from about 50 μm to about 5 cm, or from about 50 μm to about 2 cm. As above, the exact dimensions of D1, D2 and D3 are not critical so long as an enclosed volume is formed for receiving a liquid sample of volumes as described above or containers suitable for receiving such volumes. In some embodiments, a portion of third enclosure-forming component 6 is received by recess 16 of first enclosure-forming component 14 in the open position.

Device 2 may be moved from an open position to a closed position manually or automatically, where in certain embodiments at least third enclosure-forming component 6 is moved automatically and in certain embodiments the first enclosure-forming component 14 and/or second enclosure-forming component is also moved.

For example, referring to the embodiments in which third enclosure-forming component 6 is moveably attached to body 5 of second enclosure-forming component 4, when the device is placed in the open position, third enclosure-forming component 6 may be slideably moved (manually or automatically) from the resting position (in which contact plate extends beyond the leading edge of third enclosure-forming component 6) to the measurement position (in which the leading edge of third enclosure-forming component 6 extends beyond the contact plate, e.g., the leading edge of third enclosure-forming component 6 is contacted with recess 16 of first enclosure-forming component 14). Such may be accomplished automatically by a processing system that is adapted to sense when sample is present for measurement and when a measurement of a sample is completed.

Sensing whether a sample is present or not and/or when a measurement of a sample has been completed may be by way of any suitable sensing system such as a motion and/or temperature system, clock (timing system), and the like. Alternatively movement of device componentry may be set in motion upon prompt by a user, e.g., by actuating a “ON” and/or “OFF” button or the like. Alternatively, or additionally, sensing whether a sample is present or not and/or when a measurement of a sample has been completed may be gauged by detecting a stable optical property reading (i.e., one that does not change after a predetermined interval of time). In still another embodiment, movement of one or more enclosure-forming components may result in contact with a switch or other actuator which provides a signal to a processor that a closed or open position is reached.

Second enclosure-forming component 4 may be attached to moveable arm 25 as shown in FIG. 6. In this particular embodiment, moveable arm 25 is also attached to first enclosure-forming component 14, but this need not be the case. Moveable arm 25 may be configured to, e.g., automatically under the control of a suitably programmed processor, move second enclosure-forming component 4 in the direction of the arrow so as to provide the closed position, e.g., by a prompt from an operator or by sensing that a sample has been applied to first enclosure-forming component 14. In any event, arm 25 may be moved to register second enclosure-forming component 4 into operative position with respect to first enclosure-forming component 14 (i.e., to provide the second or measurement position), and in so doing third enclosure-forming component 6, that is slideably attached to second enclosure-forming component 4, may be caused, e.g., automatically, to move linearly along the shaft or body of second enclosure-forming component 4 to contact first enclosure-forming component 14 to provide enclosed space 20. That is, third enclosure-forming component 6 may be mechanically or electromechanically connected to the translational system or measurement actuation system of the device so that third enclosure-forming component 6 automatically extends as the arm is moved to move second enclosure-forming component 4 into a measurement position.

As noted above, in certain embodiments third enclosure-forming component 6 may be attached to first enclosure-forming component 14, e.g., slideably attached. In such embodiments, third enclosure-forming component 6 may be moved, manually or automatically, towards second enclosure-forming component 4 in a manner analogous to that described above. For example, third enclosure-forming component 6 may be caused to move to a measurement position automatically, e.g., by the movement of any of the first enclosure-forming component 14 and/or second enclosure-forming component 4. For example, in certain embodiments first enclosure-forming component 14 or a portion thereof may be translationally moved to a second position, and in so doing a third enclosure-forming component 6 that may be slideably attached to first enclosure-forming component 14 may be caused, e.g., automatically, to move in a direction to contact second enclosure-forming component 14 to provide enclosed space 20. That is, third enclosure-forming component 6 may be mechanically or electromechanically connected to the translational system or measurement actuation system of the device so that the shield automatically extends as first enclosure-forming component 14 or portion of first enclosure-forming component 14 is moved into a measurement position.

In certain embodiments in which third enclosure-forming component 6 is not attached to first enclosure-forming component 14 or to second enclosure-forming component 4 (but may or may not be attached to a common arm) as shown for example in FIG. 4, third enclosure-forming component 6 may be moved into the measurement position automatically or manually without movement of the first enclosure-forming component 14 and/or the second enclosure-forming component 4.

Accordingly, device 2 may be configured so that movement of any one of the enclosure-forming components may be dependant or independent of the movement of any other enclosure-forming component(s) and movement may be simultaneous or otherwise.

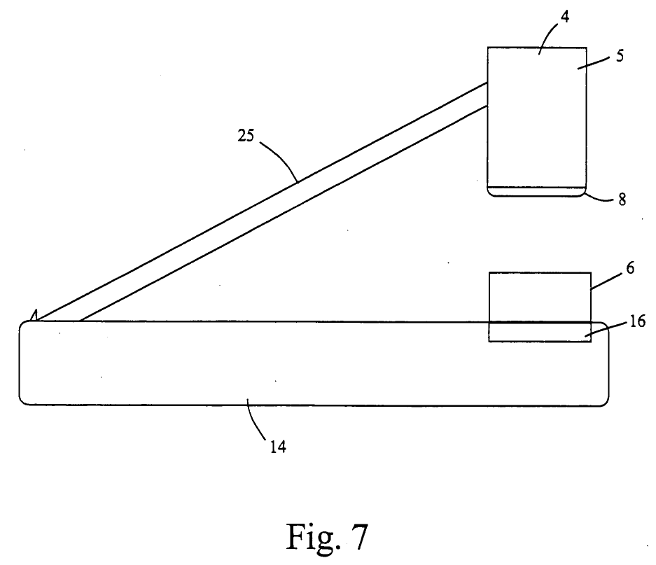

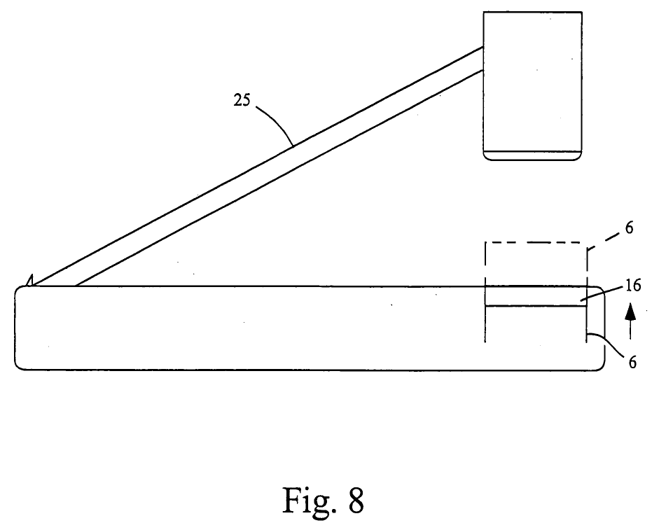

FIG. 7 shows a side view of an exemplary embodiment in which enclosure-forming component 4 is connected to moveable arm 25, which arm 25 is also connected to enclosure-forming component 14. In this embodiment, enclosure-forming component 6 is attached to enclosure-forming component 14. enclosure-forming component 6 is shown extended beyond surface 15 of enclosure-forming component 14, and may be permanently so extended or in certain embodiments enclosure-forming component 6 may be caused to so extend from a position within enclosure-forming component 14, e.g., automatically by movement of arm 25 when pivoted to move enclosure-forming component 4 into measurement position, or by otherwise moving one or more of the components of the device into measurement position. The embodiment of FIG. 8 shows enclosure-forming component 6 retracted below surface 15 of enclosure-forming component 14 in an open position and then moved in the direction of the arrow to extend beyond surface 15 to a closed position (shown in phantom). In this manner, retraction of enclosure-forming component 14 into enclosure-forming component 14 may facilitate cleaning of surface 15 of enclosure-forming component 14 and sample application to enclosure-forming component 14.

A feature of the second position is that the enclosed space is accessible by sample measurement componentry. Accordingly, the device is configured to obtain optical measurement of a sample enclosed by space 20. For example, as described above a light source and detector or optical fiber connected thereto may be positioned in optical communication with enclosed space 20, e.g., in enclosure-forming component 4 and/or enclosure-forming component 14 such as at, e.g., location 50 of FIG. 5 (light detector or optical fiber in optical communication with a detector) and location 60 of FIG. 5 (detector or an optical fiber in communication with a detector), or any other suitable location that is accessible to enclosed space 20. In those embodiments in which enclosure-forming component 6 is configured at least as a light shield to block ambient light from enclosed space 20, the closed device position is such that ambient light is prevented from being incident on the light detector (or an optical fiber thereof).

Once in the closed position, the sample measurement may be initiated so that optical measurements of the sample may be obtained. Initiation of the sample measurement mode may be manual or automatic, e.g., may be initiated by prompt from an operator or may be initiated automatically by a suitably programmed processing system once the device assumes a closed position. In some aspects, sample measurement responds to feedback from a monitoring system which monitors movement of components of the device, e.g., initiating measurements when the first, second and third components are in the closed position to define enclosed space 20 and/or stopping measurements when the first, second and third enclosure-forming components are in the open position. In other aspect, motion of one or more of the first second and third enclosure-forming components responds to feedback from the sample measurement componentry, e.g., beginning motion after sample measurements are obtained back to an open position.

Any or all of the above-described components may be controlled manually or automatically, e.g., under the control of a processing system. The subject device may include suitable switches and timers as are known in the art for carrying out the respective functions of the various components. Such switches and timers are well known to those of skill in the art. For example, the switches could be standard electromagnetic relays or well-known solid state switching devices. The timer(s) could be a simple motor driven mechanical clock mechanism that controls the “ON” and “OFF” timing sequence for the switches.

Any suitable protocol may be used to measure an optical property, where representative protocols are described in references noted herein and elsewhere, e.g., including, but not limited to as described in U.S. Pat. Nos. 5,422,726; 5,345,395; 5,122,974; 4,252,617; 4,595,833; 3,975,098; and 3,973,129.

Computer Readable Media

Embodiments of the subject invention also include computer program products comprising computer readable media having programming stored thereon for implementing some or all of the functions of a subject device, e.g., for causing the positional relationship of the enclosure-forming components to change from an open position to a closed position as described above and to initiate sample analysis using the optical system of the device.

The computer readable media may be, for example, in the form of a computer disk or CD, a floppy disc, a magnetic “hard card”, a server, or any other computer readable media capable of containing data or the like, stored electronically, magnetically, optically or by other means. Accordingly, stored programming embodying steps for carrying-out functions of the subject devices may be transferred to a subject device or to a computer coupled to a subject device such as a personal computer (PC), (i.e., accessible by an operator or the like), by physical transfer of a CD, floppy disk, or like medium, or may be transferred using a computer network, server, or other interface connection, e.g., the Internet.

Systems

Also provided are systems that include the subject devices. Systems may include a subject device and programming recorded on a computer readable medium for causing the positional relationship of the enclosure-forming components to change from an open position to a closed position, as described above.

A system may include a subject device and a computer system such as a minicomputer, a microcomputer, a UNIX® machine, mainframe machine, personal computer (PC) such as INTEL®, APPLE®, or SUN® based processing computer or clone thereof, or other appropriate computer. A computer of a system may also include typical computer components (not shown), such as a motherboard, central processing unit (CPU), memory in the form of random access memory (RAM), hard disk drive, display adapter, other storage media such as diskette drive, CD-ROM, flash-ROM, tape drive, PCMCIA cards and/or other removable media, a monitor, keyboard, mouse and/or other user interface, a modem, network interface card (NIC), and/or other conventional input/output devices. A computer of the system may include programming for implementing some or all the functions of the subject devices, such that some or all of the functions of the device may be controlled from a computer equipped with suitable software. The system may be configured so that sample measurement data may be communicated from the device, e.g., memory of the device, to the computer for data manipulation and analysis. For example, a system may include programming configured to automate the data acquisition of raw or processed data from a subject device and save these in a memory unit of the computer to enable data analysis. For example, data may be obtained, spectra or graphical plots may be generated, manipulated and stored in a subject device and transferred to a computer program of a coupled computer for presentation.

Methods

Embodiments of the subject invention also include methods of measuring an optical property of a sample. Embodiments include positioning a sample on enclosure forming component 14 of a subject device, changing the positional relationship of enclosure-forming components from an open position to a closed position, and measuring an optical property of the sample.

The subject methods may be used with a wide variety of samples and are not to be construed to be limited to any particular sample or sample type. Samples may be in liquid or solid form. Liquid samples will be primarily used to describe the subject methods for exemplary purposes only and in no way intended to limit the scope of the subject invention. Samples may include naturally occurring or man-made samples and synthetic samples. The sample may be any of a variety of different physiological samples, where representative samples of interest include, but are not limited to: whole blood, plasma, serum, semen, saliva, tears, urine, fecal material, spinal fluid and hair; in vitro cell cultures, cells and cell components, and the like. A sample may be pre-processed prior to obtaining optical measurements thereof, e.g., may be amplified, denatured, fractionated, labeled, as is known in the art. For example, for determining low concentrations of DNA in a sample, the DNA may first be first diluted with Ethidium Bromide or the like.

To position a sample on the stage of a device, the device is positioned in an open position (see for example FIG. 1). In this manner, first enclosure-forming component 14 is accessible for sample application thereto in that an enclosed space 20 is not yet provided. The sample contacting surface of the stage (e.g., such as a contact plate) and/or second enclosure-forming component 4 are also easily accessible for cleaning if necessary, when the device is in the open position.

With the device in the open position, a sample is positioned at first enclosure-forming component 14 of the device. In embodiments in which enclosure-forming component 14 includes a transparent portion and an opaque portion, the sample is positioned on the transparent portion. In any event, the positioning of the sample is such that the sample is aligned or registered with the sample measurement componentry of the device when the device is changed to a closed position. Positioning a sample may be accomplished manually, e.g., a manually operated pipette or sample reservoir, or may be partially or completely automated, e.g., by way of a robotic pipettor or other automated fluid handling equipment, as is known in the art. In either event, the accuracy of the positioning and, where the sample is liquid, the width and height of the sample may be influenced by the surface properties of the sample stage as discussed above.

The volume of sample may vary depending on the particular sample under investigation, where volumes may range from milliliters to nanoliter and picoliter volumes as discussed above.

Once a sample is positioned in suitable position at enclosure-forming component 14, the device is changed from the open position to the closed position (see for example FIG. 5). The device may be changed manually or automatically. For example, in certain embodiments an operator will initiate the change of the device, e.g., by actuating a control knob, lever, button, or the like, which actuation will cause the device to move into the closed position or cause a motor system to change the device to the closed position. In certain embodiments, actuation of a control knob or the like will cause a processing system to execute steps to move the device into the closed position. In certain other embodiments, a device may include a sample sensor and thus once a sample is sensed at first enclosure-forming component 14, the device may automatically be changed to the closed position.

As described above, the positional relationship of the first, second and third enclosure-forming components are changed from the open position to the closed position in which the enclosure-forming components provide an enclosed space accessible by sample measurement componentry. As described above, changing the positional relationship of the device to provide an enclosed space may involve the movement of enclosure-forming component 14 and/or enclosure-forming component 4 and/or enclosure-forming component 6.

For example, in certain embodiments in which third enclosure-forming component 6 is moveably attached to second enclosure-forming component 4, movement of second enclosure-forming component 4 to the closed position (e.g., decreasing the distance between the second enclosure-forming component 4 and first enclosure-forming component 14), may cause the third enclosure-forming component 6 to slide, e.g., automatically, from its resting position in which the contact plate extends beyond the leading edge of third enclosure-forming component 6 to a position in which third enclosure-forming component 6 extends beyond the contact plate and makes contact with first enclosure-forming component 14, e.g., a recess of first enclosure-forming component 14. Accordingly, as the arm is lowered for measurement, third enclosure-forming component 6 may automatically move along the body 5 of second enclosure-forming component 4 to provide the enclosed space 20. An analogous process may be employed in embodiments in which third enclosure-forming component 6 is attached (e.g., moveably) to first enclosure-forming component 14.

In certain embodiments, third enclosure-forming component 6 is not attached to second enclosure-forming component 4 or first enclosure-forming component 14 (but may be connected to a common arm). In such embodiments, whether second enclosure-forming component 4 and/or first enclosure-forming component 14 move in the closed position, third enclosure-forming component 6 may be moved into positional relationship with second enclosure-forming component 4 and first enclosure-forming component 14 to provide the enclosed space. Any component movements may be accomplished manually or automatically.

In certain embodiments, a portion of third enclosure-forming component 6 may be deformable. In this regard, the deformable portion may deformably contact a contact surface of first enclosure-forming component 14 (e.g., a recess thereof) and/or second enclosure-forming component 4 to provide a tight seal at the interface.

In the closed position, the sample previously deposited on first enclosure-forming component 14 is bound by the enclosed space 20. As described above, the enclosed space is accessible to sample measurement componentry so that the optical measurements may be performed with the device in the closed position. In this manner, the sample as well as the sample measurement componentry is shielded from certain environmental influences while an optical property is measured. The particular environmental influences from which the sample and measurement componentry are protected will depend on a variety of factors such as the environment in which the analysis is being performed, the particulars of the enclosure-forming components such as third enclosure-forming component 6, etc. For example, in certain embodiments the enclosed space is impermeable to ambient light. In certain embodiments, the enclosed space may be impermeable to various other environmental influences, in addition to or instead of ambient light, such as moisture and/or certain gases, etc.

The enclosed space may also reduce evaporation of the sample which may occur during the measurement. This is particularly useful when multiple measurements are made from a single sample as this may increase the temperature of the sample. Because the initial sample volume may be very small, e.g., on the order of nanoliters or picoliters, any evaporation is significant and may significantly impact the accuracy of the measurement.

As noted above, certain embodiments of the closed position may include directly contacting the sample with second enclosure-forming component 4 and more specifically the contact plate of second enclosure-forming component 4. The sample may be held in place by the two opposing surfaces of the contact plate of second enclosure-forming component 4 and first enclosure-forming component 14.

Once the positional relationship of the first, second and third enclosure-forming components are such that an enclosed space is provided that is accessible by sample measurement componentry, an optical property of the sample may be measured. As described above, a variety of different techniques may be employed, e.g., photometric, spectrophotometric, fluorimetric and spectrofluorometric. Regardless of the particulars of the type of analysis, common to all is the illumination of the sample with light and the detection of the reflected or transmitted light from the sample. A “blank” may also be illuminated and the intensity of light from blank may also be measured as is commonly done in photometric, spectrophotometric, fluorimetric and spectrofluorometric type measurements. By “blank” is meant a solution that is identical to the sample solution except that the blank does not contain the solute that absorbs light. Other controls may be used to evaluate the functioning of the device as are known in the art.

Accordingly, once the device is in the measurement position with a sample in the enclosed space, the sample may be illuminated with one or more light sources (or fiber optic fiber in communication therewith). Any suitable wavelength may be used ranging from the UV to visible portions of the electromagnetic spectrum. In certain aspects, a sample is sequentially illuminated with a plurality of different wavelengths. In other aspects, a sample may be illuminated simultaneously with a plurality of different wavelengths and the desired wavelengths measured sequentially or in parallel by use of one or more of a variety of methods and devices known in the art, including by use of a filters, a grating or a prism between the sample and the detector, and the like.

Once illuminated, an optical property from the sample is detected. When light strikes an object it may be transmitted, absorbed, scattered, or reflected and as such the subject methods include observing one or more aspects related to the transmission and/or absorption and/or reflection and/or scattering of light from a sample. For example, once a beam of light is passed through the sample, the intensity of light reaching the detector or optical fiber thereof may be measured. Certain embodiments also include measuring the intensity of light passing through a blank, which measurements may be used to compute the amount of light that the sample absorbs. In other embodiments, the intensity of light passing through a reference sample comprising a known quantity of an analyte is measured.

In some embodiments, changes in amounts of light over selected time intervals may be determined, for example, when two or more agents capable of reacting with each other are included in a sample, or in a sample and on a sample-receiving surface and a change in an optical property of a sample provides a means for detecting whether a reaction between the two or more agents has taken place.

Signal from the detector may then be communicated to a processor for manipulation, e.g., to compute the amount of light that a sample absorbs or the like. The amount of sample a light absorbs may be used to derive other useful information about the sample, e.g., the concentration of the light absorbing molecule in the sample, e.g., DNA, RNA, proteins, polypeptides, peptides, organic molecules, salts, cells (e.g., bacterial cells) or the like. A processor may perform photometric measurements, spectral scanning, quantitative determination, kinetic measurements, etc. For example, data may be communicated to a processor that may execute the steps necessary to generate spectra or graphical plots.

In certain embodiments, data from at least one of the detecting and deriving steps, as described above, may be transmitted to a remote location. The data may be transmitted to the remote location for further evaluation and/or use. Any convenient telecommunications means may be employed for transmitting the data, e.g., facsimile, modem, Internet, etc.

The subject methods also find use in high throughput sample analysis formats. For example, two or more of the subject devices may be combined together to provide a system of a plurality of such devices so that multiple samples may be analyzed simultaneously or sequentially or a by a combination of simultaneous and sequential analysis. Such systems may be further optimized by the use of automated fluid handling systems.

The subject methods find use in a variety of applications. Measurements and knowledge of the optical properties of materials are used in a wide variety of application areas such as: the chemical, pharmaceutical, optical components and coatings, food, aerospace, glass, energy, construction and water treatment industries, materials science, thermal control in buildings and spacecraft, infrared tracking and guidance systems, environmental, health and military agencies. The subject methods may be particularly useful in life science research and development, particularly for nucleic acid, primer, and protein quantitation.

Enclosure-Forming Components

Also provided are enclosure-forming components, analogous to the third enclosure-forming components 6 described above that may be used with optical measuring devices to provide an enclosed space accessibly by sample measurement componentry. Embodiments include enclosure-forming components 6 according to the subject invention that may be employed to retrofit optical measuring devices so that the optical measurement devices may include an enclosure-forming component 6. For example, the subject invention includes enclosure-forming components 6 for use with optical measuring devices or for upgrading optical measurement devices to include an enclosure-forming component 6. Accordingly, the subject invention contemplates separate or stand-alone enclosure-forming components 6 that may be adapted to fit optical measuring devices, e.g., optical measuring devices that were not originally manufactured to include such an enclosure-forming component.

Kits

In aspects of the subject invention, one or more of the devices or elements thereof, e.g., as described above, may be present in a kit format. Elements that may be present in a kit format include, but are not limited to, one or more of: an optical measuring device; one or more enclosure-forming components (such as first enclosure-forming component 14 and/or second enclosure-forming component 4 and/or third enclosure-forming component 6), a computer readable medium on which programming is recorded for practicing the subject methods, etc. For example, a computer readable medium may include programming for operating a subject device to change the positional relationship of the components of the device between open and closed positions. The subject kits may also include instructions for how to use a subject device to measure an optical property of a sample. The instructions may be recorded on a suitable recording medium or substrate. For example, the instructions may be printed on a substrate, such as paper or plastic, etc. As such, the instructions may be present in the kits as a package insert, in the labeling of the container of the kit or components thereof (i.e., associated with the packaging or sub-packaging) etc. In other embodiments, the instructions are present as an electronic storage data file present on a suitable computer readable storage medium, e.g., CD-ROM, diskette, etc. In yet other embodiments, the actual instructions are not present in the kit, but means for obtaining the instructions from a remote source, e.g. via the internet, are provided. An example of this embodiment is a kit that includes a web address where the instructions can be viewed and/or from which the instructions can be downloaded. As with the instructions, this means for obtaining the instructions is recorded on a suitable substrate.

The kits may further include one or more additional components necessary for carrying out the measurement of an optical property of a sample, such as sample preparation reagents, buffers, labels for labeling components of interest of a sample such as for labeling a nucleic acid or the like, etc. As such, the kits may include one or more containers such as vials or bottles, with each container containing a separate component for the measurement of an optical property of a sample.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

1. A device comprising:
(a) optical componentry; and
(b) first and second enclosure-forming components,
wherein said first enclosure-forming component comprises a substantially planar sample receiving surface and said second enclosure-forming component is movable in an up and down direction with respect to said planar surface of said first enclosure-forming component,
wherein said device is configured so that said enclosure-forming components have a positional relationship that can change from an open position to a closed position in which said first enclosure-forming component and said second enclosure forming component define an enclosed space accessible by said optical componentry, and
wherein said first enclosure-forming component is in optical communication with said optical componentry when the device is in the closed position; and
(c) a third enclosure-forming component, wherein said third enclosure-forming component comprises a surface parallel to said sample-receiving surface and is capable of moving from said open position to said closed position when said sample-receiving surface extends beyond an edge of said parallel surface of said third enclosure-forming component.

2. The device of claim 1, wherein said one or more enclosure-forming components comprise a first enclosure-forming component, a second enclosure-forming component and a third enclosure-forming component.

3. The device of claim 1, wherein at least two of said first, second and third enclosure-forming components are moveable.

4. The device of claim 1, wherein said first and second enclosure-forming components comprise said optical componentry or are in communication with said optical componentry.

5. The device of claim 1, wherein said first enclosure-forming component comprises the sample-receiving surface.

6. A device comprising:
(a) optical componentry; and
(b) first and second enclosure-forming components,
wherein said first enclosure-forming component comprises a substantially planar sample receiving surface and said second enclosure-forming component is movable in an up and down direction with respect to said planar surface of said first enclosure-forming component,
wherein said device is configured so that said enclosure-forming components have a positional relationship that can change from an open position to a closed position in which said first enclosure-forming component and said second enclosure forming component define an enclosed space accessible by said optical componentry,
wherein said first enclosure-forming component is in optical communication with said optical componentry when the device is in the closed position, and
wherein one or more of said enclosure-forming components is a shield-forming component that shields the enclosed space from ambient light, wherein said shield-forming component is moveably attached to a component forming a sample-receiving surface, wherein an edge of said sample-receiving surface extends beyond an edge of a shield-forming component when the device is in the open position and an edge of the shield-forming component extends beyond the edge of the sample-receiving surface when the device is in the closed position.

7. The device of claim 6, wherein at least a portion of said shield-forming component(s) is deformable.

8. The device of claim 6, wherein said shield-forming component(s) are opaque.

9. The device of claim 6, wherein said shield-forming component(s) are reflective.

10. The device of claim 1, wherein said third enclosure-forming component is moveably attached to said second enclosure-forming component.

11. The device of claim 10, wherein said second enclosure-forming component is moveable and movement of said second enclosure-forming component causes said first enclosure-forming component to move from said open position to said closed position.

12. The device of claim 1, wherein said third enclosure-forming component is moveably attached to said first enclosure-forming component.

13. (canceled)

14. The device of claim 1, wherein said sample-receiving surface is substantially flat.

15. The device of claim 6, wherein an enclosure-forming component for shielding the enclosed space from ambient light is movably attached to an enclosure-forming component comprising optical componentry.

16. The device of claim 6, wherein an enclosure-forming component for shielding the enclosed space from ambient light is movably attached to an enclosure-forming component comprising a surface parallel to the sample-receiving surface.

17. The device of claim 1, wherein said device comprises a photometer, spectrophotometer, fluorimeter, or spectrofluorimeter.

18. The device of claim 1, wherein said optical componentry comprises at least one of a light source, a light detector, and an optical waveguide.

19. The device of claim 6, wherein at least one of said shield-forming components is attached to a component forming a sample-receiving surface.

20. The device of claim 19, wherein said at least one shield-forming component is moveably attached to said component forming a sample-receiving surface.

21-25. (canceled)

26. The device of claim 1 wherein a component surface comprising a portion which contacts a sample comprises surface energy characteristics for securing or confining a-liquid sample within boundaries of the portion.

27. The device of claim 26; wherein the sample-contacting portion is more hydrophilic than surrounding regions of the component surface that comprises the sample-contacting portion.

28-30. (canceled)

31. A method of measuring an optical property of a sample, said method comprising: (a) positioning a sample on an sample-receiving surface of a device according to claim 1; (b) changing said positional relationship of components of the device from said open position to said closed position; and (c) measuring an optical property of said sample.

32. The method of claim 31, wherein said changing comprises moving said enclosure-forming components.

33. The method of claim 31, wherein the second enclosure-forming component comprises a surface substantially parallel to the sample-receiving surface.

34-43. (canceled)
